(19) United States
(12) Patent Application Publication
(10) Pub. No.: US 2024/0124762 A1
(43) Pub. Date: Apr. 18, 2024

(54) CONCENTRATED OPPOSITELY CHARGED SURFACTANTS USED FOR CHEMICAL ENHANCED OIL RECOVERY UNDER HIGH SALINITY AND HIGH TEMPERATURE RESERVOIR CONDITIONS

(71) Applicant: Saudi Arabian Oil Company, Dhahran (SA)

(72) Inventors: Ming Han, Dhahran (SA); Limin Xu, Beijing (CN)

(73) Assignee: Saudi Arabian Oil Company, Dhahran (SA)

(21) Appl. No.: 18/520,092

(22) Filed: Nov. 27, 2023

Related U.S. Application Data
(63) Continuation of application No. PCT/CN2021/142710, filed on Dec. 29, 2021.

(51) Int. Cl. C09K 8/584

(52) U.S. Cl. CPC C09K 8/584

(57) ABSTRACT

A process for reducing the interfacial tension between a hydrocarbon fluid and a surfactant mixture during chemical enhanced oil recovery includes introducing a surfactant mixture solution comprising an anionic surfactant, a cationic surfactant, a nonionic surfactant, a brine solution, and a co-solvent to a hydrocarbon-bearing reservoir under conditions of a salinity of greater than or equal to 50,000 mg/L, a hardness of greater than or equal to 2,500 mg/L, and a temperature of greater than or equal to 90° C., thereby reducing the interfacial tension at a liquid-liquid interface of the hydrocarbon fluid and the surfactant mixture solution. The anionic surfactant comprises organo sulfate. The cationic surfactant comprises quaternary ammonium, brominated trimethylammonium, chloride trimethylammonium, or combinations thereof. The nonionic surfactant comprises polyoxyethylene fatty acid ester, phenylated ethoxylate, or combinations thereof.

### CROSS-REFERENCE TO RELATED APPLICATIONS

This Application is a continuation of International Application No PCT/CN2021/142710, filed Dec. 29, 2021, the entire contents of which are incorporated herein by reference.

### TECHNICAL FIELD

Embodiments of the present disclosure generally relate to chemical enhanced oil recovery processes using surfactant mixture solutions comprising an anionic surfactant, a cationic surfactant, a nonionic surfactant, a brine solution, and a co-solvent in order to reduce interfacial tension between a hydrocarbon fluid and surfactant mixture solutions.

### BACKGROUND

Reservoir fluids, for example, crude oil, often have high levels of interfacial tension (IFT). Chemical solutions having chemical mixtures are introduced to a reservoir during chemical enhanced oil recovery (CEOR) in order to decrease the IFT between the reservoir fluids and the chemical solutions. Reservoir fluids generally include hydrocarbon fluids. Conventional chemical solutions are generally alkaline or caustic solutions that are injected into the reservoirs that have naturally-occurring organic acids. However, once introduced to a reservoir, such chemical solutions do not show sustained, decreased IFT after exposure to the high-salinity and high-temperature reservoir conditions (that is, a salinity greater than or equal to about 50,000 milligrams per liter (mg/L) and a temperature greater than or equal to about 90 degrees Celsius (° C.)), which are common in fluid reservoirs, as the chemical solutions become insoluble. Such insolubility results in formation damage and an unwanted increase in IFT. The increased IFT between the reservoir fluids and conventional chemical solutions results in decreased potential oil recovery from the hydrocarbon-bearing reservoir.

Further, conventional chemical solutions may have chemical mixtures with different charges. Mixing these chemical mixtures may require a high dissolution temperature (i.e., greater than or equal to about 90° C.) and be time consuming. Due to the high dissolution temperature, these conventional chemical mixtures are easy to precipitate at room temperature (from about 20° C. to about 30° C.). Thus, chemical solutions having chemical mixtures with different charges are developed for field application. However, mixing these chemical mixtures with different charges on-site for application is complicate and inconvenient.

### SUMMARY

Accordingly, there is an ongoing need for chemical solutions having an improved compatibility and stability at room temperature while reducing the IFT at high-salinity and high-temperature conditions found in hydrocarbon-bearing reservoirs. Embodiments of the present disclosure meet this need by utilizing surfactant mixture solutions comprising an anionic surfactant, a cationic surfactant, a nonionic surfactant, a brine solution, and a co-solvent. Surfactant mixture comprising an anionic surfactant, a cationic surfactant, and a nonionic surfactant may reduce the IFT by two to three orders of magnitude. Co-solvent may reduce a dissolution temperature of surfactant mixture solutions and forms a stable concentrated formulation at room temperature without affecting the low IFT between the hydrocarbon fluid and the surfactant mixture solution. Further, based on their surface properties, surfactant molecules adsorb droplets of hydrocarbon fluid at the liquid-liquid interface by inserting the hydrophobic group into the hydrocarbon fluid and placing the hydrophilic group in the water phase. The hydrocarbon fluid disperses in the water and forms a stable emulsion. Thus oil production during commercial CEOR processes may be increased.

According to one or more embodiments of the present disclosure, a process for reducing the interfacial tension between a hydrocarbon fluid and a surfactant mixture solution during chemical enhanced oil recovery includes introducing a surfactant mixture solution comprising an anionic surfactant, a cationic surfactant, a nonionic surfactant, a brine solution, and a co-solvent to a hydrocarbon-bearing reservoir under conditions of a salinity of greater than or equal to 50,000 mg/L, a hardness of greater than or equal to 2,500 mg/L, and a temperature of greater than or equal to 90° C., thereby reducing the interfacial tension at a liquid-liquid interface of the hydrocarbon fluid and the surfactant mixture solution.

Additional features and advantages of the embodiments described in the present disclosure will be set forth in the detailed description which follows, and in part will be readily apparent to those skilled in the art from that description or recognized by practicing the embodiments described in the present disclosure, including the detailed description which follows, the claims, as well as the appended drawings.

### BRIEF DESCRIPTION OF THE DRAWINGS

FIG. 1 is a graph of the interfacial tension between Example 8 and the crude oil (y-axis) as a function of the logarithm of time (x-axis);

FIG. 2 is a graph of oil recovery and differential pressure (y-axis) as a function of injection volume (x-axis) according to one or more embodiments of the present disclosure; and

FIG. 3 is a graph of oil recovery and differential pressure (y-axis) as a function of injection volume (x-axis) according to coreflooding using polymer only.

### DETAILED DESCRIPTION

As used in this disclosure, the term “hydrocarbon fluid” may refer to a hydrocarbon-bearing fluid, such as crude oil, natural gas, petroleum, diesel fuel, gasoline, or any other fluids that include an amount of hydrocarbons. Moreover, this term may include fluids of all phases, such as any substance that continually deforms (flows) under an applied shear stress, or external force. Examples of such substances include liquids, gases, and plasmas. In embodiments, the hydrocarbon fluid may include water present in hydrocarbon-bearing reservoirs.

As used in this disclosure, the term “salinity” may refer to the concentration of dissolved salts in a liquid and is reported in this disclosure in units of milligrams per liter (mg/L).

As used in this disclosure, the term “hardness” may refer to the concentration of dissolved calcium and magnesium in a liquid and is reported in this disclosure in units of milligrams per liter (mg/L).

Embodiments of the present disclosure are directed to processes for reducing the interfacial tension between a hydrocarbon fluid and a surfactant mixture solution during chemical enhanced oil recovery. The process includes introducing a surfactant mixture solution comprising an anionic surfactant, a cationic surfactant, a nonionic surfactant, a brine solution, and a co-solvent to a hydrocarbon-bearing reservoir under conditions of a salinity of greater than or equal to 50,000 mg/L, a hardness of greater than or equal to 2,500 mg/L, and a temperature of greater than or equal to 90° C., thereby reducing the interfacial tension at a liquid-liquid interface of the hydrocarbon fluid and the surfactant mixture solution.

In general, chemical solutions used during CEOR decrease the IFT between the hydrocarbon fluids and the chemical solutions. IFT is the amount or work (that is, units of force that may be measured in newtons) which must be expended in order to increase the size of the interface between two adjacent phases which do not mix completely with one another. The main forces involved in IFT are adhesive forces (tension) between the liquid phase of one substance and either a solid, liquid or gas phase of another substance. A measure of the IFT is millinewtons per meter (mN/m). A lesser IFT value signifies decreased IFT between the two adjacent phases, which is a desirable property as it correlates to increased oil recovery, while a greater IFT value signifies increased IFT between two adjacent phases. The process of the present disclosure may reduce the IFT between the hydrocarbon fluid and the surfactant mixture solution during CEOR by utilizing surfactant mixture solutions, thereby increasing oil production during commercial CEOR processes. The process of the present disclosure may further improve compatibility and stability of surfactant mixture solutions at room temperature by utilizing nonionic surfactant and co-solvent.

The process of the present disclosure include introducing a surfactant mixture solution comprising an anionic surfactant, a cationic surfactant, a nonionic surfactant, a brine solution, and a co-solvent to a hydrocarbon-bearing reservoir under high salinity and high temperature conditions (a salinity of greater than or equal to 50,000 mg/L, and a temperature of greater than or equal to 90° C.). The interfacial tension at a liquid-liquid interface of the hydrocarbon fluid and the surfactant mixture solution may be reduced by introducing the surfactant mixture solution.

The hydrocarbon-bearing reservoir may be under a condition of a salinity of greater than or equal to 50,000 mg/L. In embodiments, the hydrocarbon-bearing reservoir may be under a condition of a salinity of greater than or equal to 55,000 mg/L, 60,000 mg/L, 65,000 mg/L, 70,000 mg/L, 75,000 mg/L, 80,000 mg/L, 85,000 mg/L, 90,000 mg/L, 95,000 mg/L, 100,000 mg/L, 125,000 mg/L, 150,000 mg/L, 175,000 mg/L, 200,000 mg/L, or 220,000 mg/L. In some embodiments, the hydrocarbon-bearing reservoir may be under a condition of a salinity of from 50,000 mg/L to 220,000 mg/L, from 55,000 mg/L to 200,000 mg/L, from 60,000 mg/L to 175,000 mg/L, from 65,000 mg/L to 150,000 mg/L, from 70,000 mg/L to 125,000 mg/L, from 75,000 mg/L to 100,000 mg/L, or from any other range between 50,000 mg/L and 220,000 mg/L.

The hydrocarbon-bearing reservoir may be under a condition of a total dissolved solids of greater than or equal to 50,000 mg/L. In embodiments, the hydrocarbon-bearing reservoir may be under a condition of a total dissolved solids of greater than or equal to 55,000 mg/L, 60,000 mg/L, 65,000 mg/L, 70,000 mg/L, 75,000 mg/L, 80,000 mg/L, 85,000 mg/L, 90,000 mg/L, 95,000 mg/L, 100,000 mg/L, 125,000 mg/L, 150,000 mg/L, 175,000 mg/L, 200,000 mg/L, or 220,000 mg/L. In some embodiments, the hydrocarbon-bearing reservoir may be under a condition of a total dissolved solids of from 50,000 mg/L to 220,000 mg/L, from 55,000 mg/L to 200,000 mg/L, from 60,000 mg/L to 175,000 mg/L, from 65,000 mg/L to 150,000 mg/L, from 70,000 mg/L to 125,000 mg/L, from 75,000 mg/L to 100,000 mg/L, or from any other range between 50,000 mg/L and 220,000 mg/L.

The hydrocarbon-bearing reservoir may be under a condition of a temperature of greater than or equal to 90° C. In embodiments, the hydrocarbon-bearing reservoir may be under a condition of a temperature of greater than 95° C., 100° C., 105° C., 110° C., 115° C., 120° C., 125° C., 130° C., 140° C., 150° C., 160° C., 175° C., or 200° C. In some embodiments, the hydrocarbon-bearing reservoir may be under a condition of a temperature of from 95° C. to 200° C., from 100° C. to 200° C., from 100° C. to 175° C., from 100° C. to 150° C., from 100° C. to 125° C., from 125° C. to 200° C., from 125° C. to 175° C., from 125° C. to 150° C., from 150° C. to 200° C., from 150° C. to 175° C., or from any other range between 90° C. and 200° C.

In embodiments, the hydrocarbon fluid may include naturally-occurring hydrocarbon fluids present in hydrocarbon-bearing reservoirs. Suitable hydrocarbon fluids may include water, brine, oil, diesel fuel, petroleum-based hydrocarbon fluids, or any other suitable hydrocarbon fluids. In some embodiments, the hydrocarbon fluid may include crude oil having an American Petroleum Institute (API) gravity ranging from 10° to 70°. The hydrocarbon fluid may have API gravity from 20° to 60°, from 20° to 50°, from 20° to 40°, from 25° to 40°, from 25° to 35°, from 27° to 34°, from 30° to 33°, or from 31° to 33°. In some embodiments, the API gravity of the hydrocarbon fluid is 31°.

The surfactant mixture solution comprises an anionic surfactant, a cationic surfactant, a nonionic surfactant, a brine solution, and a co-solvent. The surfactant mixture solution may reduce the IFT between the hydrocarbon fluid and the surfactant mixture solution during CEOR, thereby increasing oil production during commercial CEOR processes. The surfactant mixture solution may improve compatibility and stability of surfactant mixture solutions at room temperature.

The surfactant mixture solution comprises the anionic surfactant. The anionic surfactant comprises organosulfate. Suitable organosulfates include sodium dodecyl sulfate (SDS), sodium lauryl sulfonate (SLS), or both.

The surfactant mixture solution comprises the cationic surfactant. The cationic surfactant comprises quaternary ammonium, brominated trimethylammonium, chloride trimethylammonium, or combinations thereof.

The cationic surfactant may include a quaternary ammonium. The quaternary ammonium may have the formula CₙH₂ₙ₋₄XN (which will be referred to as “formula (I)”), in which X is a halogen. The subscript n denotes the number of repeating units of the chemical species in the formula (I). In some embodiments, subscript n ranges from 11 to 25, from 13 to 25, from 15 to 25, from 17 to 23, or from any other suitable range between 11 and 25. In embodiments, X is a halogen selected from fluorine, chlorine, bromine, or iodine. Suitable quaternary ammonium compounds include a halogenated cetylpyridinium, such as cetylpyridinium fluoride, cetylpyridinium chloride, cetylpyridinium bromide, or cetylpyridinium iodide.

The cationic surfactant may include a brominated trimethylammonium. The brominated trimethylammonium may have the formula CₙH₂ₙ₊₄BrN (which will be referred to as “formula (II)”). The subscript n denotes the number of repeating units of the chemical species in formula (II). In some embodiments, subscript n ranges from 3 to 25, from 9 to 25, from 13 to 25, from 15 to 25, from 15 to 21, from 15 to 19, or from any other suitable range between 3 and 25. As subscript n increases in value, the compatibility performance of the surfactant mixture, which will be described later in this disclosure in greater detail, may decrease. Therefore, in certain embodiments, subscript n is less than 15. Suitable brominated trimethylammonium compounds may include dodecyltrimethylammonium bromide (DTAB), tetradecyltrimethylammonium bromide (TTAB), cetyltrimethylammonium bromide (CTAB), or combinations thereof.

The cationic surfactant may include a chloride trimethylammonium. The chloride trimethylammonium may have the formula CₙH₂ₙ₊₄ClN (which will be referred to as “formula (III)”). The subscript n denotes the number of repeating units of the chemical species in formula (III). In some embodiments, subscript n ranges from 3 to 25, from 9 to 25, from 13 to 25, from 15 to 25, from 15 to 21, from 15 to 19, or from any other suitable range between 3 and 25. As subscript n increases in value, the compatibility performance of the surfactant mixture, which will be described later in this disclosure in greater detail, may decrease. Therefore, in certain embodiments, subscript n is less than 15. Suitable chloride trimethylammonium may include dodecyltrimethylammonium chloride (DTAC), tetradecyltrimethylammonium chloride (TTAC), cetyltrimethylammonium chloride (CTAC), or combinations thereof.

Still referring to the surfactant mixture solution, the surfactant mixture solution comprises the nonionic surfactant. The nonionic surfactant comprises polyoxyethylene fatty acid ester, phenylated ethoxylate, or combinations thereof.

In embodiments, polyoxyethylene fatty acid ester may have the formula CₙH₂ₙO₂(OCH₂CH₂)ₘ (which will be referred to as “formula (IV)”). The subscripts m and n denote the number of repeating units of the chemical species in formula (IV). In some embodiments, subscript m in formula (IV) ranges from 1 to 40, from 3 to 38, from 5 to 36, from 7 to 34, from 9 to 32, from 11 to 30, from 13 to 28, from 15 to 26, from 17 to 24, or any other suitable range between 1 and 40. In one or more embodiments, subscript n in formula (IV) ranges from 4 to 40, from 5 to 35, from 6 to 31, from 7 to 30, from 8 to 29, from 9 to 28, from 10 to 27, from 11 to 26, from 12 to 25, from 13 to 24, from 14 to 23, from 15 to 22, from 16 to 21, from 17 to 20, from 18 to 19, or any other suitable range between 4 and 40.

Non-limiting specific examples of polyoxyethylene saturated fatty acid esters according to formula (IV) may include polyoxyethylenes of butyric, valeric, caproic, enanthic, caprylic, pelargonic, capric, undecylic, lauric, tridecylic, myristic, pentadecanoic, palmitic, margaric, stearic, nonadecylic, arachidic, heneicosylic, behenic, tricosylic, lignoceric, pentacosylic, cerotic, heptacosylic, montanic, nonacosylic, melissic, hentriacontylic, lacceroic, psyllic, geddic, ceroplastic, hexatriacontylic, heptatriacontanoic, octatriacontanoic, nonatriacontanoic, or tetracontanoic acids. In embodiments, the polyoxyethylene saturated fatty acid comprises polyoxyethylene stearate.

In embodiments, the polyoxyethylene fatty acid ester comprises polyoxyethylene sorbitan saturated fatty acid ester, polyoxyethylene sorbitan unsaturated fatty acid ester, or both. In some embodiments, polyoxyethylene sorbitan saturated fatty acid ester may have the formula CₙH₂ₙ₋₂O₆(OCH₂CH₂)ₘ (which will be referred to as “formula (V)”). The subscript n denotes the number of repeating units of the chemical species in formula (V). In some embodiments, subscript n in formula (V) ranges from 18 to 24, from 18 to 22, or from 18 to 20, or any other suitable range between 18 and 24. In one or more embodiments, subscript m in formula (V) ranges from 20 to 25 or from any other suitable range between 20 and 25. In embodiments, the polyoxyethylene sorbitan saturated fatty acid ester may include polyoxyethylene sorbitan monostearate. Suitable commercial embodiments of polyoxyethylene sorbitan saturated fatty acid ester nonionic surfactants include TWEEN® 60 from Sigma-Aldrich Co. (St. Louis, Missouri).

In some embodiments, polyoxyethylene sorbitan unsaturated fatty acid ester may have the formula CₙH₂ₙ₋₄O₆(OCH₂CH₂)ₘ (which will be referred to as “formula (VI)”). The subscript n denotes the number of repeating units of the chemical species in formula (VI). In some embodiments, subscript n in formula (VI) ranges from 18 to 24, from 18 to 22, or from 18 to 20, or any other suitable range between 18 and 24. In one or more embodiments, subscript m in formula (VI) ranges from 20 to 25 or from any other suitable range between 20 and 25.

Non-limiting specific examples of polyoxyethylene sorbitan unsaturated fatty acid esters according to formula (VI) may include the polyoxyethylene sorbitan unsaturated fatty acid esters of oleic acid (such as oletate), elaidic acid, gondoic acid, erucic acid, nervonic acid, or mead acid. In certain embodiments, the polyoxyethylene sorbitan unsaturated fatty acid comprises oleate. Suitable commercial embodiments of polyoxyethylene unsaturated fatty acid nonionic surfactants include TWEEN® 80 from Sigma-Aldrich Co. (St. Louis, Missouri).

In embodiments, the phenylated ethoxylate may have the general formula (VII):

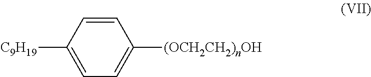

In formula (VII), the subscript n denotes the number of repeating units of the chemical species. In some embodiments, subscript n ranges from 4 to 30, from 6 to 30, from 8 to 30, from 10 to 30, from 12 to 30, from 14 to 30, from 15 to 30, from 20 to 30, from 4 to 20, from 6 to 20, from 8 to 20, from 10 to 20, from 12 to 20, from 14 to 20, from 15 to 20, from 4 to 15, from 6 to 15, from 8 to 15, from 10 to 15, from 12 to 15, from 14 to 15, from 4 to 14, from 6 to 14, from 8 to 14, from 10 to 14, from 12 to 14, from 4 to 12, from 6 to 12, from 8 to 12, from 10 to 12, from 4 to 10, from 6 to 10, from 8 to 10, from 4 to 8, from 6 to 8, or any other range from 4 to 30. In certain embodiments, subscript n is 10. Suitable phenylated ethoxylate nonionic surfactants are commercially available as MAKON® OP-4, MAKON® OP-6, MAKON® OP-8, MAKON® OP-10, MAKON® OP-12, MAKON® OP-14, MAKON® OP-15, MAKON® OP-20, and MAKON® OP-30 from Stepan Co. (Northfield, Illinois).

In embodiments, the phenylated ethoxylate may have the general formula (VIII):

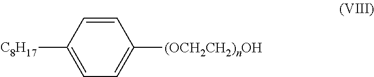

In formula (VIII), the subscript n denotes the number of repeating units of the chemical species. In these embodiments, subscript n is 9. Suitable phenylated ethoxylate nonionic surfactants are commercially available as MAKON® OP-9, MAKON® OP-10, MAKON® OP-13, MAKON® OP-15, or MAKON® OP-20, all of which are available from Stepan Co. (Northfield, Illinois).

In embodiments, the surfactant mixture solution may comprise from 0.001 percent by weight (wt. %) to 60 wt. % of the surfactant mixture based on the total weight of the surfactant mixture solution. In some embodiments, the surfactant mixture solution may comprise from 0.001 percent by weight (wt. %) to 10 wt. %, from 0.01% to 1 wt. %, from 0.02 wt. % to 1 wt. %, from 0.03 wt. % to 1 wt. %, from 0.04 wt. % to 1 wt. %, from 0.05 wt. % to 1 wt. %, from 0.1 wt. % to 0.5 wt. %, from 0.1 wt. % to 0.25 wt. %, from 0.1 wt. % to 0.2 wt. %, from 0.12 wt. % to 0.18 wt. %, from 0.12 wt. % to 0.16 wt. %, from 0.14 wt. % to 0.16 wt. %, or from any range between 0.001 wt. % and 60 wt. %, based on the total weight of the surfactant mixture solution. In embodiments, the surfactant mixture solution may be diluted to from 0.001 wt. % to 0.5 wt. %, or from 0.05 wt. % to 0.3 wt. % for field application.

In embodiments, the surfactant mixture may comprise from 50 wt. % to 99.9 wt. % of the anionic surfactant and the cationic surfactant, based on the total weight of the surfactant mixture. In some embodiments, the surfactant mixture may comprise from 50 wt. % to 95 wt. %, from 50 wt. % to 90 wt. %, from 50 wt. % to 85 wt. %, from 50 wt. % to 80 wt. %, from 55 wt. % to 99 wt. %, from 55 wt. % to 95 wt. %, from 55 wt. % to 90 wt. %, from 55 wt. % to 85 wt. %, from 55 wt. % to 80 wt. %, from 60 wt. % to 99 wt. %, from 60 wt. % to 95 wt. %, from 60 wt. % to 90 wt. %, from 60 wt. % to 85 wt. %, from 60 wt. % to 80 wt. %, or from any range between 50 wt. % to 99.9 wt. % of the anionic surfactant and the cationic surfactant, based on the total weight of the surfactant mixture.

In embodiments, the molar ratio of the cationic surfactant to the anionic surfactant may be from 1:4 to 4:1. In some embodiments, the molar ratio of the cationic surfactant to the anionic surfactant is 1:4 to 3:2, 1:4 to 2:1, 2:3 to 4:1, 2:3 to 3:2, 2:3 to 2:1, or from any range between 1:4 and 4:1 based on the total weight of the surfactant mixture.

In embodiments, the surfactant mixture comprises from 0.01% wt. % to 50 wt. % of the nonionic surfactant, based on the total weight of the surfactant mixture. In some embodiments, the surfactant mixture comprises from 0.01% wt. % to 45 wt. %, from 0.01% wt. % to 40 wt. %, from 0.01% wt. % to 35 wt. %, from 0.01% wt. % to 30 wt. %, from 0.01% wt. % to 25 wt. %, from 0.01% wt. % to 20 wt. %, from 1% wt. % to 45 wt. %, from 1% wt. % to 40 wt. %, from 1% wt. % to 35 wt. %, from 1% wt. % to 30 wt. %, from 1% wt. % to 25 wt. %, from 1% wt. % to 20 wt. %, from 5% wt. % to 45 wt. %, from 5% wt. % to 40 wt. %, from 5% wt. % to 35 wt. %, from 5% wt. % to 30 wt. %, from 5% wt. % to 25 wt. %, from 5% wt. % to 20 wt. %, or from any range between 0.01% wt. % and 50 wt. % of the nonionic surfactant based on the total weight of the surfactant mixture.

In embodiments, the mass ratio of the cationic surfactant and the anionic surfactant to the nonionic surfactant is from 10:1: to 1:1. In some embodiments, the mass ratio of the cationic surfactant and the anionic surfactant to the nonionic surfactant is from 8:1 to 2:1, from 6:1 to 4:1, or from any range between 10:1 and 1:1.

Still referring to the surfactant mixture solution, the surfactant mixture solution comprises the brine solution and the co-solvent. In some embodiments, prior to introducing the surfactant mixture solution to the hydrocarbon-bearing reservoir, the co-solvent may be added in the brine solution to produce the solution mixture.

The surfactant mixture solution comprises the brine solution. In embodiments, the brine solution comprises a concentration of inorganic salts dissolved in water. The brine solution may include naturally-occurring brines (for example, seawater), synthetic brines, or both. In embodiments, the brine solution comprises deionized water. In some embodiments, the brine solution comprises one or more alkali or alkaline earth metal halides. Non-limiting specific examples suitable alkali or alkaline earth metal halides include calcium chloride, calcium bromide, sodium chloride, sodium bromide, magnesium chloride, magnesium bromide and combinations thereof.

In embodiments, the brine solution may have a salinity of greater than or equal to 50,000 mg/L in the hydrocarbon-bearing reservoir. In some embodiments, the brine solution may have a salinity of greater than or equal to 55,000 mg/L, 60,000 mg/L, 65,000 mg/L, 70,000 mg/L, 75,000 mg/L, 80,000 mg/L, 85,000 mg/L, 90,000 mg/L, 95,000 mg/L, 100,000 mg/L, 125,000 mg/L, 150,000 mg/L, 175,000 mg/L, 200,000 mg/L, or 220,000 mg/L. In some embodiments, the brine solution may have a salinity of from 50,000 mg/L to 220,000 mg/L, from 55,000 mg/L to 200,000 mg/L, from 60,000 mg/L to 175,000 mg/L, from 65,000 mg/L to 150,000 mg/L, from 70,000 mg/L to 125,000 mg/L, from 75,000 mg/L to 100,000 mg/L, or from any other range between 50,000 mg/L and 220,000 mg/L.

In embodiments, the brine solution may have a total dissolved solids of greater than or equal to 50,000 mg/L in the hydrocarbon-bearing reservoir. In some embodiments, the brine solution may have a total dissolved solids of greater than or equal to 55,000 mg/L, 60,000 mg/L, 65,000 mg/L, 70,000 mg/L, 75,000 mg/L, 80,000 mg/L, 85,000 mg/L, 90,000 mg/L, 95,000 mg/L, 100,000 mg/L, 125,000 mg/L, 150,000 mg/L, 175,000 mg/L, 200,000 mg/L, or 220,000 mg/L. In some embodiments, the brine solution may have a total dissolved solids of from 50,000 mg/L to 220,000 mg/L, from 55,000 mg/L to 200,000 mg/L, from 60,000 mg/L to 175,000 mg/L, from 65,000 mg/L to 150,000 mg/L, from 70,000 mg/L to 125,000 mg/L, from 75,000 mg/L to 100,000 mg/L, or from any other range between 50,000 mg/L and 220,000 mg/L.

In embodiments, the brine solution may have a hardness of greater than or equal to 2,500 mg/L in the hydrocarbon-bearing reservoir. In some embodiments, the brine solution may have a hardness of greater than or equal to 2,750 mg/L, 3,000 mg/L, 3,250 mg/L, 3,500 mg/L, 3,750 mg/L, 4,000 mg/L, 4,250 mg/L, 4,500 mg/L, 4,750 mg/L, or 5,000 mg/L. In some embodiments, the brine solution may have a hardness of from 2,500 mg/L to 5,000 mg/L, from 2,750 mg/L to 4,750 mg/L, from 3,000 mg/L to 4,500 mg/L, from 3,250 mg/L to 4,250 mg/L, from 3,500 mg/L to 4,000 mg/L, or from any other range between 2,500 mg/L and 5,000 mg/L.

In embodiments, the brine solution may have a temperature of greater than or equal to 90° C. in the hydrocarbon-bearing reservoir. In some embodiments, the brine solution may have a temperature of greater than or equal to 95° C., 100° C., 105° C., 110° C., 115° C., 120° C., 125° C., 130° C., 140° C., 150° C., 160° C., 175° C., or 200° C. In some embodiments, the brine solution may have a temperature of greater than or equal to a temperature of from 95° C. to 200° C., from 100° C. to 200° C., from 100° C. to 175° C., from 100° C. to 150° C., from 100° C. to 125° C., from 125° C. to 200° C., from 125° C. to 175° C., from 125° C. to 150° C., from 150° C. to 200° C., from 150° C. to 175° C., or from any other range between 90° C. and 200° C.

The surfactant mixture solution comprises the co-solvent. In embodiments, the co-solvent may reduce a dissolution temperature of the brine solution by at least 5° C., at least 3° C., or at least 2° C.

In embodiments, the co-solvent comprises alcohol. In some embodiments, the co-solvent comprises ethanol, isopropanol, propanol, isobutanol, butanol, or combinations thereof.

In embodiments, the surfactant mixture solution comprises from 5 wt. % to 30 wt. %, from 5 wt. % to 25 wt. %, from 5 wt. % to 20 wt. %, from 10 wt. % to 30 wt. %, from 10 wt. % to 25 wt. %, from 10 wt. % to 20 wt. %, from 10 wt. % to 18 wt. % of the co-solvent, or from any other range between 5 wt. % and 30 wt. %, based on the total weight of the surfactant mixture solution.

In embodiments, the amount of the brine solution is greater than the amount of the co-solvent. In embodiments, the mass ratio of the brine solution to the co-solvent is from 4:1 to 3:2, from 7:2 to 4:2, from 3:1 to 5:2, or from any other range between 4:1 and 3:2.

In some embodiments, prior to introducing the surfactant mixture solution to the hydrocarbon-bearing reservoir, the surfactant mixture may be dissolved in the solution mixture to produce the surfactant mixture solution. In embodiments, the surfactant mixture solution has a dissolution temperature of less than or equal to 32° C., or less than or equal to 30° C. In some embodiments, the surfactant mixture solution has a dissolution temperature of from 18° C. to 32° C., from 18° C. to 30° C., from 20° C. to 32° C., from 20° C. to 30° C., or from any other range between 18° C. to and 32° C.

In embodiments, the mass ratio of the solution mixture to surfactant mixture is from 1:2 to 100:1, from 1:10 to 10:1, from 1:20 to 20:1, or from any other range between 1:2 and 100:1. In embodiments, the mass ratio of the solution mixture to surfactant mixture is 1:1.

In embodiments, the mass ratio of the surfactant mixture to the co-solvent is from 10:1 to 1:1, from 8:1 to 2:1, from 6:1 to 3:1, or from any other range between 10:1 and 1:1.

### EXAMPLES

The following examples illustrate one or more additional features of the present disclosure described previously. It should be understood that these examples are not intended to limit the scope of the disclosure or the appended claims in any manner.

### Examples 1-4 and Comparative Example 1—Dissolution Temperature 1

Table 1 below shows the formulations used to form and dissolution temperature of Examples 1-4 and Comparative Example 1. To prepare Examples 1-4 and Comparative Example 1, the solution mixture including a brine solution with or without a co-solvent was prepared. The brine solution chosen was seawater having salinity (total dissolved solids) of 57,670 mg/L and hardness of 2760 mg/L at 95° C. In Examples 1-4, the co-solvent was added to the brine solution. In Example 1, 20 wt. % of ethanol was used as a co-solvent based on the total weight of the surfactant mixture solution. In Example 2, 20 wt. % of isopropanol was used as a co-solvent based on the total weight of the surfactant mixture solution. In Example 3, 18 wt. % of propanol was used as a co-solvent based on the total weight of the surfactant mixture solution. In Example 4, 10 wt. % of isobutanol was used as a co-solvent based on the total weight of the surfactant mixture solution.

To prepare the surfactant mixture solution, the nonionic surfactant was added to the solution mixture. The nonionic surfactant chosen was MAKON® OP-10 from Stepan Co. Then, the cationic surfactant was added to the solution mixture. The cationic surfactant chosen was DTAC (Dodecyl Trimethyl Ammonium Chloride) from Sinopharm. The anionic surfactant was then added to the solution mixture. The anionic surfactant chosen was SDS (Sodium Dodecyl Sulfate) from Sinopharm. The molar ratio of the DTAC to SDS based on the total weight of the surfactant mixture, represented by the equation nSDS/nDTAC, was 1/2. The amount of the surfactant mixture was 50 wt. % based on the total weight of the surfactant mixture solution.

TABLE 1

| | Example | | Example | | Example | | Example | | Comparative | |
|---|---|---|---|---|---|---|---|---|---|---|
| Components | 1 | | 2 | | 3 | | 4 | | Example 1 | |
| SDS | 0.707 | g | 0.707 | g | 0.707 | g | 0.707 | g | 0.707 | g |
| DTAC | 1.293 | g | 1.293 | g | 1.293 | g | 1.293 | g | 1.293 | g |
| MAKON ® | 0.5 | g | 0.5 | g | 0.5 | g | 0.5 | g | 0.5 | g |
| OP-10 | | | | | | | | | | |
| Deionized | 1.5 | g | 1.5 | g | 1.6 | g | 2.0 | g | 2.5 | g |
| water | | | | | | | | | | |
| Co-solvent | Ethanol | | Isopropanol | | Propanol | | Isobutanol | | — | |
| | 1.0 | g | 1.0 | g | 0.9 | g | 0.5 | g | | |
| Total | 5 | g | 5 | g | 5 | g | 5 | g | 5 | g |
| Dissolution | 28 | | 25 | | 22 | | 20 | | 33 | |

Temperature
(° C.)

As shown in Table 1, co-solvents reduce the dissolution temperature of the surfactant mixture solutions from 33° C. to from 20° C. to 28° C.

### Examples 5-7 and Comparative Example 2—Dissolution Temperature 2

Table 2 below shows the formulations used to form and dissolution temperature of Examples 5-7 and Comparative Example 2. To prepare Examples 5-7 and Comparative Example 2, the solution mixture including a brine solution with or without a co-solvent was prepared. The brine solution chosen was seawater having salinity (total dissolved solids) of 57,670 mg/L and hardness of 2760 mg/L at 95° C. In Examples 5-7, the co-solvent was added to the brine solution. In Example 5, 20 wt. % of ethanol was used as a co-solvent based on the total weight of the surfactant mixture solution. In Example 6, 20 wt. % of isopropanol was used as a co-solvent based on the total weight of the surfactant mixture solution. In Example 7, 15 wt. % of isobutanol was used as a co-solvent based on the total weight of the surfactant mixture solution.

To prepare the surfactant mixture solution, the nonionic surfactant was added to the solution mixture. The nonionic surfactant chosen was MAKON® OP-10. Then, the cationic surfactant was added to the solution mixture. The cationic surfactant chosen was DTAC. The anionic surfactant was then added to the solution mixture. The anionic surfactant chosen was SLS and. The molar ratio of the DTAC to SLS based on the total weight of the surfactant mixture, represented by the equation nSLS/nDTAC, was 1/1. The amount of the surfactant mixture was 50 wt. % based on the total weight of the surfactant mixture solution.

TABLE 2

| | | | | | | | Comparative | |
|---|---|---|---|---|---|---|---|---|
| Components | Example 5 | | Example 6 | | Example 7 | | Example 2 | |
| SLS | 0.707 | g | 0.707 | g | 0.707 | g | 0.707 | g |
| DTAC | 1.293 | g | 1.293 | g | 1.293 | g | 1.293 | g |
| MAKON ® OP-10 | 0.5 | g | 0.5 | g | 0.5 | g | 0.5 | g |
| Deionized water | 1.5 | g | 1.5 | g | 2.0 | g | 2.5 | g |
| Co-solvent | Ethanol | | Isopropanol | | Isobutanol | | — | |
| | 1.0 | g | 1.0 | g | 0.5 | g | | |
| Total | 5 | g | 5 | g | 5 | g | 5 | g |
| Dissolution | 30 | | 28 | | 26 | | 43 | |

Temperature (° C.)

As shown in Table 2, co-solvents reduce the dissolution temperature of the surfactant mixture solutions from 43° C. to from 26° C. to 30° C.

### Examples 8-9 and Comparative Examples 3 and 4—Compatibility and IFT Tests 1

To prepare Examples 8 and 9, the solution mixture including a brine solution with a co-solvent was prepared. In Example 8, the brine solution chosen was seawater having salinity (total dissolved solids) of 57,670 mg/L and hardness of 2,760 mg/L at 95° C. In Example 9, the brine solution chosen was connate water having salinity (total dissolved solids) of 213,734 mg/L and hardness of 21,479 mg/L at 95° C. In Examples 8 and 9, 18 wt. % of propanol was used as a co-solvent based on the total weight of the surfactant mixture solution.

To prepare the surfactant mixture solution, the nonionic surfactant was added to the solution mixture. The nonionic surfactant chosen was MAKON OP-10. Then, the cationic surfactant was added to the solution mixture. The cationic surfactant chosen was DTAC. The anionic surfactant was then added to the solution mixture. The anionic surfactant chosen was SDS and. The molar ratio of the DTAC to SDS based on the total weight of the surfactant mixture, represented by the equation nSDS/nDTAC, was 1/2. The amount of the surfactant mixture was 0.2 wt. % based on the total weight of the surfactant mixture solution.

To prepare Comparative Example 3, the same compositions of the surfactant mixture and the brine solution of Example 8 were mixed without co-solvent. To prepare Comparative Example 4, the same compositions of the surfactant mixture and the brine solution of Example 9 were mixed without co-solvent.

For compatibility tests of Examples 8-9 and Comparative Example 3-4, the solution mixtures were prepared and placed in an oven at 95° C. for 48 hours so as to gauge the compatibility of the surfactant mixture at high temperatures. In all of the following tables, the letter “B” signifies a slightly hazy solution. The letter “A” signifies a clear solution, the letter “C” signifies a hazy solution, and the letter “D” signifies precipitation. The letters “A”, and “B” indicate good solubility.

Further, IFTs of Examples 8-9 and Comparative Examples 3-4 were measured using a spinning drop tensiometer and are listed in Table 3.

TABLE 3

| | | | Comparative | Comparative |
|---|---|---|---|---|
| | Example 8 | Example 9 | Example 3 | Example 4 |
| Compatibility | B | B | B | D |
| (95° C.) | | | | |
| Minimum IFT | 0.0044 | — | 0.0035 | insoluble |
| (mN/m, 90° C.) | | | | |
| Equilibrium IFT | 0.026 | 0.063 | 0.013 | insoluble |
| (mN/m, 90° C.) | | | | |

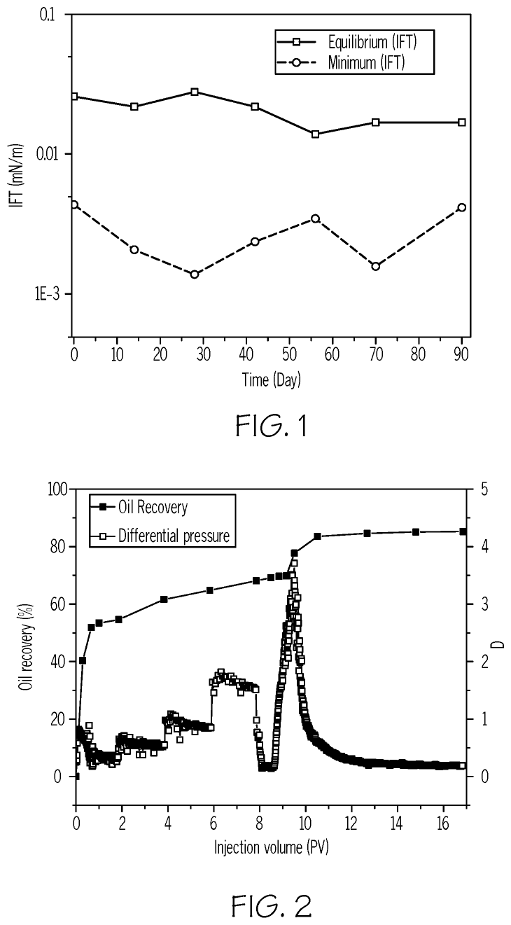

As shown in Table 3, the nonionic surfactants presented good solubility (the letter “B”) when used in conjunction with SDS and DTAC in a brine solution with propanol at high temperatures. Further, the equilibrium IFTs between 0.2 wt. % surfactant mixture and the crude oil was 0.026 mN/m in seawater and 0.063 mN/m in connate water at 90° C. Further, as shown in FIG. 1, the low IFTs between Example 8 and crude oil were maintained after aging at 95° C. for 90 days.

### Examples 10-11 and Comparative Examples 5 and 6—Compatibility and IFT Tests 2

To prepare Examples 10 and 11, the solution mixture including a brine solution with a co-solvent was prepared. In Example 10, the brine solution chosen was seawater having salinity (total dissolved solids) of 57,670 mg/L and hardness of 2,760 mg/L at 95° C. In Example 11, the brine solution chosen was connate water having salinity (total dissolved solids) of 213,734 mg/L and hardness of 21,479 mg/L at 95° C. In Examples 10 and 11, 10 wt. % of isobutanol was used as a co-solvent based on the total weight of the surfactant mixture solution.

To prepare the surfactant mixture solution, the nonionic surfactant was added to the solution mixture. The nonionic surfactant chosen was MAKON OP-10. Then, the cationic surfactant was added to the solution mixture. The cationic surfactant chosen was DTAC. The anionic surfactant was then added to the solution mixture. The anionic surfactant chosen was SLS and. The molar ratio of the DTAC to SLS based on the total weight of the surfactant mixture, represented by the equation nSLS/nDTAC, was 1/1. The amount of the surfactant mixture was 0.2 wt. % based on the total weight of the surfactant mixture solution.

To prepare Comparative Example 5, the same compositions of the surfactant mixture and the brine solution of Example 10 were mixed without co-solvent. To prepare Comparative Example 6, the same compositions of the surfactant mixture and the brine solution of Example 11 were mixed without co-solvent.

Compatibility and IFT tests described in Examples 8 and 9 were conducted for Examples 10-11 and Comparative Examples 5-6 and are listed in Table 4.

TABLE 4

| | | | Comparative | Comparative |
|---|---|---|---|---|
| | Example 10 | Example 11 | Example 5 | Example 6 |
| Compatibility | B | B | B | D |
| (95° C.) | | | | |
| Minimum IFT | — | 2 × 10 − 4 | — | insoluble |
| (mN/m, 90° C.) | | | | |
| Equilibrium IFT | 0.031 | 0.022 | 0.045 | insoluble |
| (mN/m, 90° C.) | | | | |

As shown in Table 4, the nonionic surfactants presented good solubility when used in conjunction with SLS and DTAC in a brine solution with isobutanol at high temperatures. Further, the IFTs between 0.2 wt. % surfactant mixture and the crude oil was 0.031 mN/m in seawater and 0.022 mN/m in connate water at 90° C.

Coreflooding Tests

Coreflooding tests were conducted at 95° C. using carbonate core (Diameter: 3.8 cm, length: 4.05 cm, brine permeability: 260 mD, oil saturation: 74%). First, the core plug was saturated with connate water by vacuum. Then, the coreflooding system was set up by pre-charging the accumulator with connate water, brine, crude oil, and surfactant mixture in aqueous solution. Also, the core plug was loaded into the core holder. Once system setup was completed, the permeability of the brine was tested by setting the confining pressure to 600 psi (4.14 Megapascal (MPa)) and the back pressure to 100 psi (0.69 MPa). Water (brine) was injected into the core sample at different flow rates (that is, 0.5 cc/min, 1.0 cc/min and 2.0 cc/min) and the differential in pressure produced was recorded. The brine permeability was then calculated using Darcy's Law. The polymer used for the test was partially hydrolyzed polyacrylamide (the brand AB3300, manufactured by Anhui Tianrun Chemicals Co., Ltd).

After calculating the brine permeability, the core plug was removed from the set up, and saturated with crude oil by high speed centrifuge at 6,000 revolutions per minute (rpm) for 1 hour. The centrifuge direction was reversed and the core plug was again saturated with crude oil by high speed centrifuge at 6,000 rpm for 1 hour. The weight of the core plug was recorded both before and after saturation. The core plug was then aged at 95° C. for three weeks so as to recover the wettability.

The core plug was then loaded into the core holder. The confining pressure was set to 600 psi (4.14 MPa) and the back pressure was set to 100 psi (0.69 MPa). Fresh crude oil was then injected into the core plug so as to displace the aged oil. Upon displacement, the temperature and pressure of the set up were adjusted so as to mirror reservoir conditions. As such, the temperature was adjusted to 96° C., the confining pressure was set at 4,500 psi (31.03 MPa), and the pore pressure was set at 3,100 psi (21.37 MPa).

The aged core plug was first flushed by the fresh crude oil to displace the aged oil out. Four flow rates were used from 0.5 to 4 cc/min (0.5 cc/min, 1.0 cc/min, 2.0 cc/min, and 4.0 cc/min). Water flood started with a flow rate of 0.5 cc/min. A bump flood was then performed using flow rate of 1 cc/min, 2 cc/min, and 4 cc/min to eliminate the capillary end effect. After water flood, 1 pore volume (PV) of chemical slug including a co-solvent (propanol), a surfactant mixture comprising SDS, DTAC, and MAKON® OP-10, and a polymer AB3300 at a flowrate of 0.5 cc/min. The last step was post water flood with a flow rate of 0.5 cc/min until 100% water cut, produced water content. The produced fluid mixture was then collected and the amount of oil volume produced by the coreflooding process was recorded.

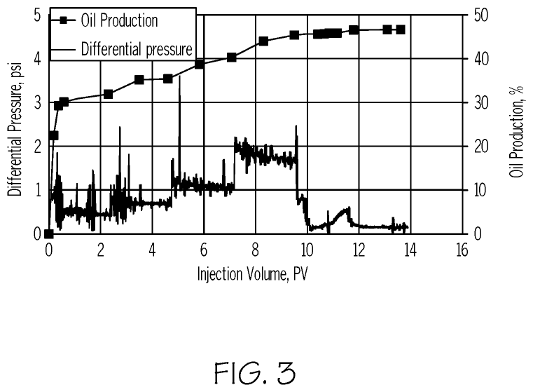

As shown in FIG. 2, coreflooding using this surfactant mixture solution and polymer showed a significant increase in oil recovery. The oil recovery of water flooding was 69.7%. Further, the oil recovery was increased by 15.5% by 1 pore volume (PV) surfactant-polymer injection and the following post water injection in tertiary mode. The increase of the oil recovery of 15.5% demonstrates that surfactant mixture-polymer flooding with co-solvent is efficient in increasing oil recovery. The total recovery reached 82.2%. Such an injection lowers the interfacial tension between the surfactant mixture and the crude oil present in the hydrocarbon-bearing reservoirs, thereby increasing oil recovery upon a later seawater flush treatment. In contrast, as shown in FIG. 3, for coreflooding using polymer (AB3300) only, the oil recovery after water flooding was 45.8%. The recovery increased to only 46.7% after polymer and post water flooding. The oil production increased by less than 1%.

According to one aspect of the present disclosure, a process for reducing the interfacial tension between a hydrocarbon fluid and a surfactant mixture during chemical enhanced oil recovery includes introducing a surfactant mixture solution comprising an anionic surfactant, a cationic surfactant, a nonionic surfactant, a brine solution, and a co-solvent to a hydrocarbon-bearing reservoir under conditions of a salinity of greater than or equal to 50,000 mg/L, a hardness of greater than or equal to 2,500 mg/L, and a temperature of greater than or equal to 90° C., thereby reducing the interfacial tension at a liquid-liquid interface of the hydrocarbon fluid and the surfactant mixture solution. The anionic surfactant comprises organosulfate. The cationic surfactant comprises quaternary ammonium, brominated trimethylammonium, chloride trimethylammonium, or combinations thereof. The nonionic surfactant comprises polyoxyethylene fatty acid ester, phenylated ethoxylate, or combinations thereof.

A second aspect of the present disclosure may include the first aspect, further comprising: adding the co-solvent in the brine solution to produce a solution mixture, and dissolving the surfactant mixture comprising the anionic surfactant, the cationic surfactant, and the nonionic surfactant in the solution mixture to produce the surfactant mixture solution, where the surfactant mixture solution has a dissolution temperature of less than or equal to 30 Celsius (° C.).

A third aspect of the present disclosure may include the first aspect or the second aspect, where the hydrocarbon fluid comprises crude oil.

A fourth aspect of the present disclosure may include any of the first through third aspects, where the surfactant mixture solution comprises from 0.001 wt. % to 60 wt. % of the surfactant mixture, based on the total weight of the surfactant mixture solution.

A fifth aspect of the present disclosure may include any of the first through fourth aspects, where the organosulfate comprises sodium dodecyl sulfate (SDS), sodium lauryl sulfonate (SLS), or both.

A sixth aspect of the present disclosure may include any of the first through fifth aspects, where the quaternary ammonium comprises cetylpyridinium bromide (CPB).

A seventh aspect of the present disclosure may include any of the first through sixth aspects, where the brominated trimethylammonium comprises dodecyltrimethylammonium bromide (DTAB), tetradecyltrimethylammonium bromide (TTAB), cetyltrimethylammonium bromide (CTAB), or combinations thereof.

An eighth aspect of the present disclosure may include any of the first through seventh aspects, where the chloride trimethylammonium comprises dodecyltrimethylammonium chloride (DTAC), tetradecyltrimethylammonium chloride (TTAC), cetyltrimethylammonium chloride (CTAC), or combinations thereof.

A ninth aspect of the present disclosure may include any of the first through eighth aspects, where the polyoxyethylene fatty acid ester comprises polyoxyethylene sorbitan saturated fatty acid ester, polyoxyethylene sorbitan unsaturated fatty acid ester, or both.

A tenth aspect of the present disclosure may include any of the first through ninth aspects, where the polyoxyethylene sorbitan saturated fatty acid ester comprises polyoxyethylene sorbitan monostearate.

An eleventh aspect of the present disclosure may include any of the first through tenth aspects, where the polyoxyethylene sorbitan unsaturated fatty acid comprises oleate.

A twelfth aspect of the present disclosure may include any of the first through eleventh aspects, where the co-solvent comprises ethanol, isopropanol, propanol, isobutanol, butanol, or combinations thereof.

A thirteenth aspect of the present disclosure may include any of the first through twelfth aspects, where the surfactant mixture solution comprises from 10 wt. % to 20 wt. % of the co-solvent, based on the total weight of the surfactant mixture solution.

A fourteenth aspect of the present disclosure may include any of the first through thirteenth aspects, where the surfactant mixture solution comprises from 0.01 wt. % to 2.0 wt. % of the surfactant mixture, based on the total weight of the surfactant mixture solution.

A fifteenth aspect of the present disclosure may include any of the first through fourteenth aspects, where the surfactant mixture comprises from 50 wt. % to 99.9 wt. % of the anionic surfactant and the cationic surfactant, based on the total weight of the surfactant mixture.

A sixteenth aspect of the present disclosure may include any of the first through fifteenth aspects, where the surfactant mixture comprises from 0.01% wt. % to 50 wt. % of the nonionic surfactant, based on the total weight of the surfactant mixture.

A seventeenth aspect of the present disclosure may include any of the first through sixteenth aspects, where the molar ratio of the cationic surfactant to the anionic surfactant is from 1:4 to 4:1, based on the total weight of the surfactant mixture.

An eighteenth aspect of the present disclosure may include any of the first through seventeenth aspects, where the mass ratio of the cationic surfactant and the anionic surfactant to the nonionic surfactant is from 10:1 to 1:1.

A nineteenth aspect of the present disclosure may include any of the first through eighteenth aspects, where the mass ratio of the solution mixture to surfactant mixture is from 1:2 to 100:1.

A twentieth aspect of the present disclosure may include any of the first through nineteenth aspects, where the mass ratio of the brine solution to the co-solvent is from 4:1 to 3:2.

A twenty first aspect of the present disclosure may include any of the first through twentieth aspects, where the mass ratio of the surfactant mixture to the co-solvent is from 10:1 to 1:1.

A twenty second aspect of the present disclosure may include any of the first through twenty first aspects, where the anionic surfactant comprises SDS or SLS, the cationic surfactant comprises DTAC, and the nonionic surfactant comprises phenylated ethoxylate, and the co-solvent comprises propanol or isobutanol

It should be apparent to those skilled in the art that various modifications and variations may be made to the embodiments described in the present disclosure without departing from the spirit and scope of the claimed subject matter. Thus it is intended that the specification cover the modifications and variations of the various embodiments described in the present disclosure provided such modifications and variations come within the scope of the appended claims and their equivalents.

What is claimed is:

1. A process for reducing interfacial tension between a hydrocarbon fluid and a surfactant mixture solution during chemical enhanced oil recovery, the process comprising:
introducing the surfactant mixture solution comprising an anionic surfactant, a cationic surfactant, a nonionic surfactant, a brine solution, and a co-solvent to a hydrocarbon-bearing reservoir under conditions of a salinity of greater than or equal to 50,000 milligrams per liter (mg/L), a hardness of greater than or equal to 2,500 mg/L, and a temperature of greater than or equal to 90° C., thereby reducing the interfacial tension at a liquid-liquid interface of the hydrocarbon fluid and the surfactant mixture solution,
where:
the anionic surfactant comprises organosulfate,
the cationic surfactant comprises quaternary ammonium, brominated trimethylammoniu, chloride trimethylammonium, or combinations thereof, and
the nonionic surfactant comprises polyoxyethylene fatty acid ester, phenylated ethoxylat, or combinations thereof.

2. The process of claim 1, further comprising:
adding the co-solvent in the brine solution to produce a solution mixture; and
dissolving the surfactant mixture comprising the anionic surfactant, the cationic surfactat, and the nonionic surfactant in the solution mixture to produce the surfactant mixture solution, where the surfactant mixture solution has a dissolution temperature of less than or equal to 30 Celsius (° C.).

3. The process of claim 1, where the hydrocarbon fluid comprises crude oil.

4. The process of claim 1, where the surfactant mixture solution comprises from 0.001 weight percent (wt. %) to 60 wt. % of the surfactant mixture, based on the total weight of the surfactant mixture solution.

5. The process of claim 1, where the organosulfate comprises sodium dodecyl sulfate (SDS), sodium lauryl sulfonate (SLS), or both.

6. The process of claim 1, where the quaternary ammonium comprises cetylpyridinium bromide (CPB).

7. The process of claim 1, where:
the brominated trimethylammonium comprises dodecyltrimethylammonium bromide (DTAB), tetradecyltrimethylammonium bromide (TTAB), cetyltrimethylammonium bromide (CTAB), or combinations thereof;
the chloride trimethylammonium comprises dodecyltrimethylammonium chloride (DTAC), tetradecyltrimethylammonium chloride (TTAC), cetyltrimethylammonium chloride (CTAC), or combinations thereof;
or both.

8. The process of claim 1, where the polyoxyethylene fatty acid ester comprises polyoxyethylene sorbitan saturated fatty acid ester, polyoxyethylene sorbitan unsaturated fatty acid ester, or both.

9. The process of claim 8, where:
the polyoxyethylene sorbitan saturated fatty acid ester comprises polyoxyethylene sorbitan monostearate;
the polyoxyethylene sorbitan unsaturated fatty acid comprises oleate;
or both.

10. The process of claim 1, where the co-solvent comprises ethanol, isopropanol, propanol, isobutanol, butanol, or combinations thereof.

11. The process of claim 1, where the surfactant mixture solution comprises from 10 wt. % to 20 wt. % of the co-solvent, based on the total weight of the surfactant mixture solution.

12. The process of claim 1, where the surfactant mixture solution comprises from 0.01 wt. % to 2.0 wt. % of the surfactant mixture, based on the total weight of the surfactant mixture solution.

13. The process of claim 1, where the surfactant mixture comprises from 50 wt. % to 99.9 wt. % of the anionic surfactant and the cationic surfactant, based on the total weight of the surfactant mixture.

14. The process of claim 1, where the surfactant mixture comprises from 0.01 wt. % to 50 wt. % of the nonionic surfactant, based on the total weight of the surfactant mixture.

15. The process of claim 1, where the molar ratio of the cationic surfactant to the anionic surfactant is from 1:4 to 4:1, based on the total weight of the surfactant mixture.

16. The process of claim 1, where the mass ratio of the cationic surfactant and the anionic surfactant to the nonionic surfactant is from 10:1: to 1:1.

17. The process of claim 1, where the mass ratio of the solution mixture to surfactant mixture is from 1:2 to 100:1.

18. The process of claim 1, where the mass ratio of the brine solution to the co-solvent is from 4:1 to 3:2.

19. The process of claim 1, where the mass ratio of the surfactant mixture to the co-solvent is from 10:1 to 1:1.

20. The process of claim 1, where:
the anionic surfactant comprises SDS or SLS,
the cationic surfactant comprises DTAC, and
the nonionic surfactant comprises phenylated ethoxylate, and
the co-solvent comprises propanol or isobutanol.
